(19) United States
(12) Patent Application Publication
(10) Pub. No.: US 2006/0182578 A1
(43) Pub. Date: Aug. 17, 2006

(54) Cart & dual use ramp for console copier relocation

(75) Inventor: Ralph C. Morton, Soda Springs, CA (US)

Correspondence Address: Mark C. Jacobs, Esq., 3033 El Camino Avenue, Sacramento, CA, 95821, US

(73) Assignee: Escalera, Inc.

(21) Appl. No.: 11/042,100

(22) Filed: Jan. 26, 2005

(51) Int. Cl. B60P 1/00

(52) U.S. Cl. 414/537

(57) ABSTRACT

A cart having a two-positionable ramp and a wheeled platform portion, for the lateral transportation of console copiers and other major appliances. The ramp has a first tapered end, and a second engagable end, engagable in two positions with the platform portion. When the ramp's second end is engaged horizontally, the first end tilts down for loading, with the tapered end being on the ground. Once loaded, the weight shift causes the ramp's first end to rise. The ramp is removed, and re-engaged vertically to the platform's second end for lateral movement of the load. The cart can be attached to an adapted stair climbing hand truck for upward/downward movement on stairs with the load retained in place on the cart.

### FIELD OF THE INVENTION

This invention pertains to a cart for transporting a console copier or other large appliance from a first location to a second location, and both laterally on the same floor as well as up and down stairs.

### BACKGROUND OF THE INVENTION

The movement of large commercial grade copiers, and copier/scanner/printers, a.k.a. “all-in-one” machines are quite cumbersome due to both their bulk and weight. Hand trucks, even ones that can climb stairs, such as those made by the assignee of this patent, cannot carry these bulky machines. There are too many risks involved to do so. The biggest problem is that the hand truck platform will not support the body of the console copier or “all-in-one” due to the physical size of the appliance.

When these machines need to be relocated, the casters thereon are relatively small and are not intended for negotiating asphalt, concrete, and heavy carpet. Their size is intended to aid short distance relocation primarily for machine service, and perhaps retrieval of dropped items, but not transportation. In addition, these casters have difficulty getting over raised thresholds. As such, the casters cannot roll. The machines need to be moved from a store or facility of the vendor to a vehicle for transport via any of several types of vehicles; such as minivans, full size vans, pickup trucks, and full size trucks; all of which have their bed floor at different elevations. Then the “box”—the vernacular of the trade for the console copiers and “all-in-one” machine—needs to be delivered to an office, which may again require movement and often the climbing of stairs to reach the ultimate installation location.

There is a need therefore for a cart capable of moving these large units both on level ground and from an elevated platform or truck bed to street level. In order to solve these transportation needs as well as the ability to go up steps either directly or indirectly, the apparatus of this invention came about. It can be loaded with the appliance, and rolled on level ground or downhill without fear of losing the load. The loaded apparatus can be placed on a forklift for a direct vertical lift to a higher elevation such as the bed of a truck. In addition the loaded apparatus can be easily attached with the appliance thereupon, to a stair climbing hand truck.

The invention accordingly comprises a device possessing the features properties and the relation of components which are exemplified in the following detailed disclosure and the scope of the application of which will be indicated in the appended claims.

For a fuller understanding of the nature and objects of the invention reference should be made to the following detailed description, taken in conjunction with the accompanying drawings.

### SUMMARY OF THE INVENTION

A cart having a platform portion and a ramp portion. The ramp portion is a dual function ramp that serves as both a vertical loading ramp and as a vertical retainer/steering guide. The ramp has a tapered first end and an engagable second end, engagable with the platform portion in two dispositions. When the ramp is attached to the cart generally horizontally, the cart back tilts upwardly and the center of gravity changes such that the cart can be loaded with a heavy appliance wherein the leading edge of the ramp touches the ground. Upon loading of the appliance, the center of gravity shifts back to the level or horizontal position. The ramp is then moved from the first horizontal position to the second vertical position, to permit the optionally tying down or strapping of the appliance to prevent movement, for transit. The steering is done by using the now vertical ramp as a steering guide.

The underside of the platform portion of the apparatus is configured to receive the tines of a fork lift or heavy duty hand truck for raising the loaded apparatus vertically for both removal from trucks and for facility storage prior to the sale thereof. The apparatus is also configured for easy attachment to a stair climbing hand truck.

It is a first object to provide a cart that can be easily loaded with heavy, bulky appliances without the need for the manual lifting of the appliance.

It is a second object to provide an appliance cart that tilts for loading and which is self-leveling.

It is a third object to provide a copier moving cart that can be raised and lowered by a forklift or hand truck.

It is a fourth object to provide a cart that can be raised up a flight of stairs by attachment thereof to a stair climbing hand truck.

These recited objects will in part be readily discernable from the specification provided herein and the appended claims. Other objects of the invention will in part be obvious and will in part appear hereinafter.

### BRIEF DESCRIPTION OF THE FIGURES

FIG. 1 is a front perspective view of the apparatus of this invention in a partially exploded view.

FIG. 2 is a top perspective view of this apparatus with the ramp in the first or horizontal position.

FIG. 3 is a rear elevational view of the apparatus with the ramp in its vertical position.

FIG. 4 is a front perspective view with the ramp in its second or vertical position.

FIG. 5 is a view similar to FIG. 4 but showing the apparatus in more detail and closeup.

FIG. 6 is a top plan view of the apparatus.

FIG. 7 is a bottom perspective view of the apparatus raised in the air while resting on the tines of a stair climbing hand truck.

FIG. 8 is aside elevational view at a first point in time showing the loading of a console copier onto the ramp portion of this invention.

FIG. 9 is the same view taken a few moments later, with the copier partially on the ramp.

FIG. 10 is the same view with the copier now straddling the platform portion and the ramp as it is being loaded.

FIG. 11 is a time freeze similar view showing the center of gravity being shifted as the copier becomes totally disposed on the platform portion.

FIG. 12 is a side elevational from the same perspective showing the copier fully loaded.

FIG. 13 is a top perspective view showing the copier loaded on the platform and strapped to the ramp disposed in the vertical position.

FIG. 14 is a front perspective view of the apparatus in an elevated position on a hand truck capable of climbing stairs.

FIG. 15 is a graphical depiction of a stair climbing hand truck carrying the cart of this invention with a copier loaded thereon, up a flight of stairs.

FIG. 16 is a closeup view of a detail of the attachment of the ramp to the platform in horizontal position.

### DESCRIPTION OF THE PREFERRED EMBODIMENT

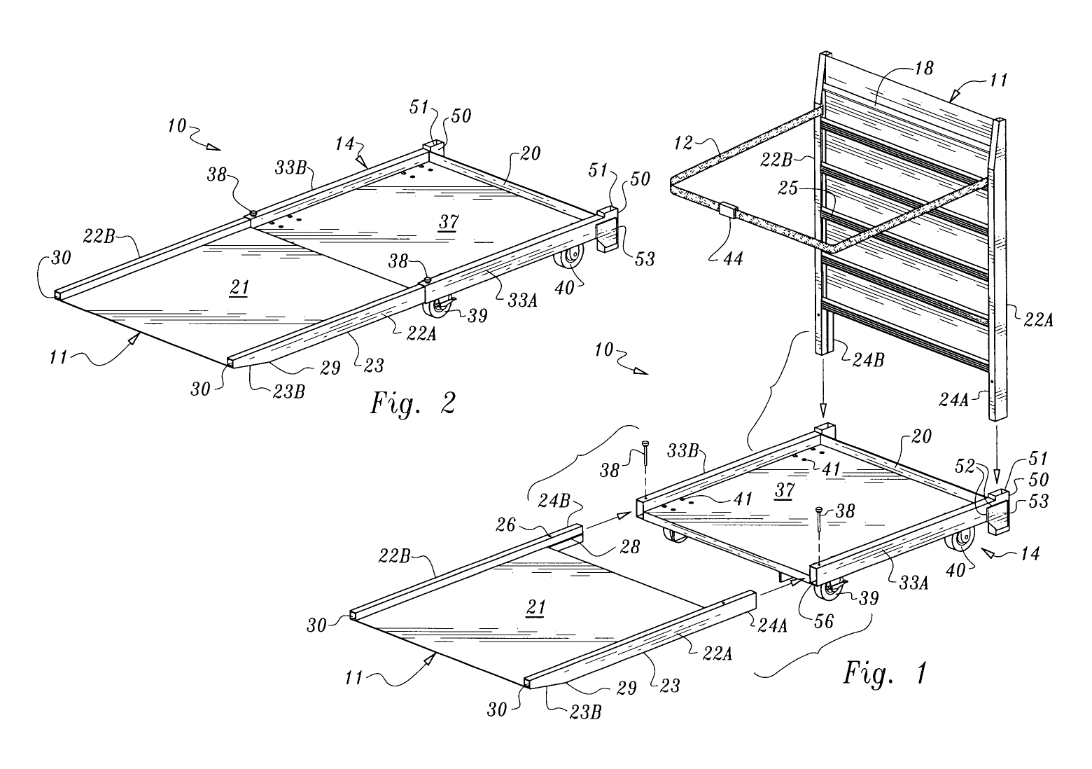

In FIG. 1, the cart of this invention is seen in an unassembled view with the ramp portion 11 shown in both its horizontal and vertical dispositions, adjacent the platform portion 14. The discussion will commence with the ramp portion. For the purpose of the directionality, the end having the locking casters 39 shall be deemed the forward end of the cart and the end with the non-locking casters 40 is deemed the rear end of the cart. Ramp 11 is formed of a skin 21 disposed within an inward facing slot 28 of each of a pair of side members 22A,22B. These side members 22A,22B may be rectangular or square tubes which have a forward positioned upwardly tapered bottom surface 23. This upwardly tapered zone commences at a point 29 on each side member and terminates at the front edge 30 of the respective side member, 22A,22B. The side members are optionally open at their front and rear surfaces. These side members are best formed as extrusions of plastic or metal.

The front edge of the skin 21 is aligned with the front edge of each of the side members 22, but the rear end of the skin terminates prior to the two extensions 24A and 24B of the side members 22A and 22B respectively. As can be seen, the sheet metal skin 37 forming part of the platform portion 14 is disposed in an inward facing slot of each of the two side members 22A and 22B. See FIG. 1.

As noted earlier, each of 22A and 22B are square tubes, which tubes are sized for a frictional engagement in the front openings 34A,34B of the two side members 33A, 33B of the platform portion 14. The balance of the construction of the platform portion is similar to but not the exact same as the construction of the ramp, and will now be described.

The platform is also seen to comprise a skin section 37 disposed within the mirror image slots 56 of the two side rails 33A,33B. The underside of the skin 37 will be discussed infra. A rear wall 20 is disposed at the rear end of the platform portion. The rear wall extends upwardly no higher than the side rails 33B and 33A of the platform portion and is disposed between them.

The front locking casters are riveted or bolted by their mounting plates not seen, to the skin 37 of the ramp by each of four bolts or rivets 41. The rear non-locking casters are similarly mounted in the two rear corners of the platform portion by bolts/rivets 41, again as seen in FIG. 1.

The rear of the two preferably tubular side members 33A,33B are closed off by arm receivers 50 which may be welded or otherwise attached to close off the rear open ends of the two tubular side members 33A,33B. The welds 52 attach the flange plate section 53 of the respective arm receivers to the respective side member. Of course an insert not seen, may be provided from the arm receiver into the open tube to aid in the closure of the open rear ends of the side members. Each receiver 50 also has a vertically disposed opening 51 sized to receive an arm 24A or 24B of the ramp.

As can be seen from the second ramp shown spaced from the platform portion, the ramp 11 also has a single reinforcement brace 18 between the tapered sections 23 and a series of spaced cross members 25 on the underside thereof disposed rearwardly of the brace 18 and between the two side members to support the platform skin 37. These cross members 25 may be tubular or bar stock as may be desired. The bracing members are conventionally attached as by bolts or welding or even adhesive depending upon the nature of the materials employed, high tensile plastic or metal such as steel or aluminum. A conventional security strap 12 to be used to encircle a copier or other large appliance is shown conventionally attached to the ramp. It is within the knowledge of the art as to how to attach a security strap for package retention.

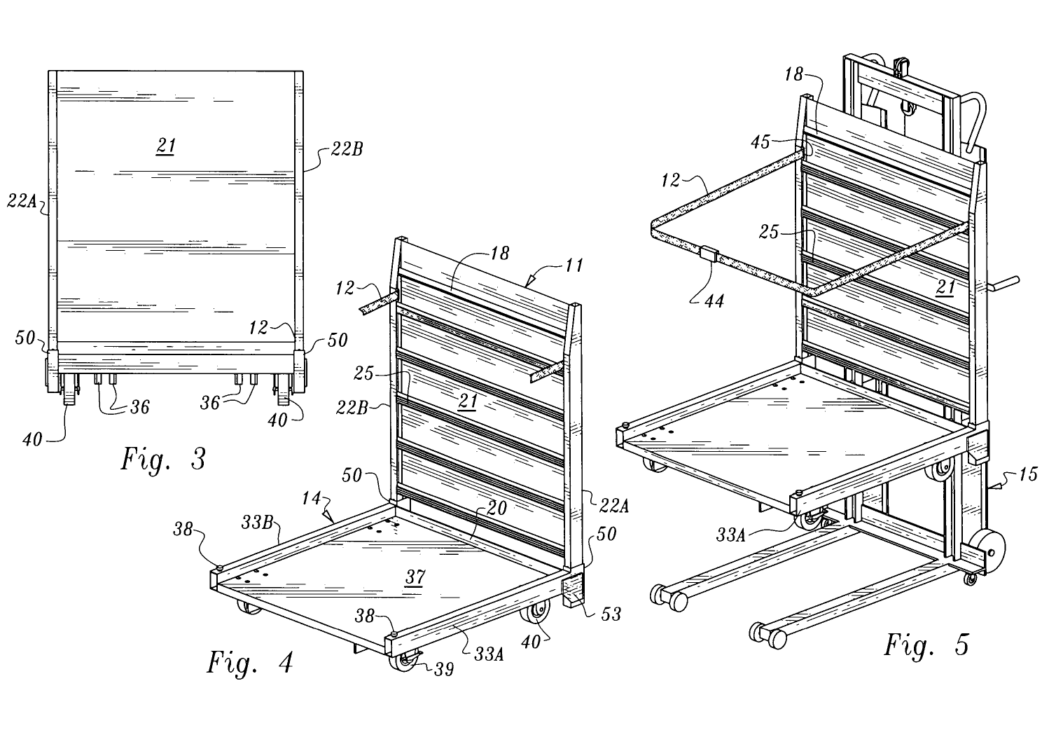

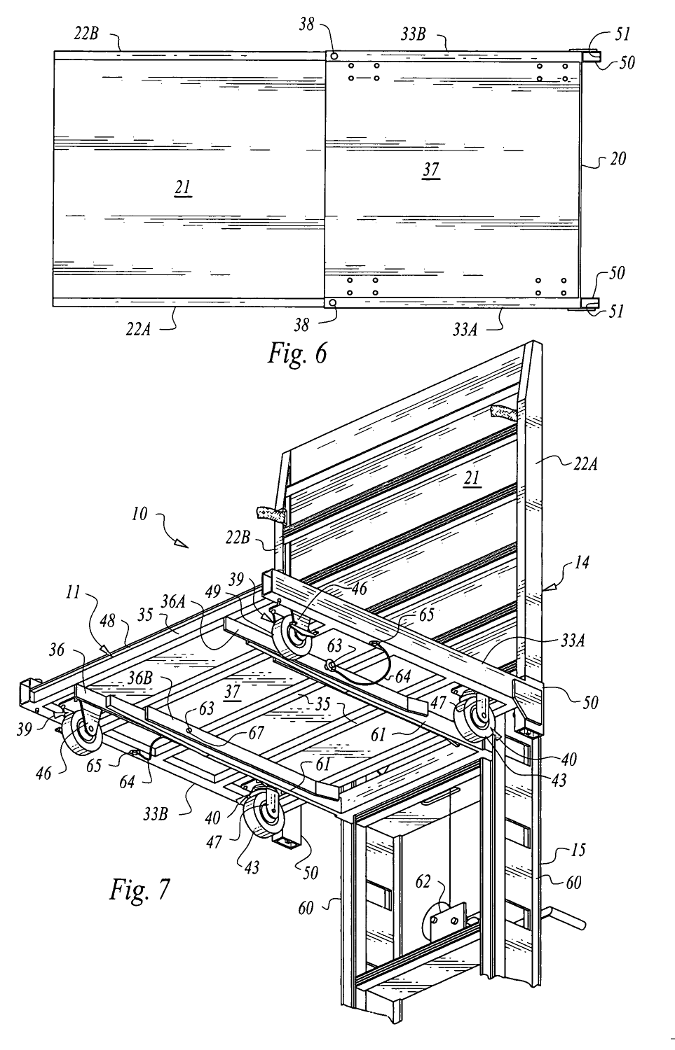

Reference is now made to FIGS. 2,3 and 6. FIG. 3 is a rear vertical view showing the second ramp—actually the only ramp, relocated to the vertical position and installed for use in the platform portion 14. Note how the skin facing the viewer is smooth, just as in the front depicted ramp of FIG. 1. FIG. 2 is a perspective view while FIG. 6 is a top plan view of the ramp inserted into the platform, IE, extensions 24A, 24B have been inserted into openings 34a,34b. FIG. 4 is another related figure. It is a perspective view showing the ramp having been relocated from the front horizontal position to the rear vertical position on the platform portion.

While taken out of order, FIG. 16 is the next figure for discussion as it is germane to the material currently being discussed. In FIG. 1, a pair of spaced lock pins 38 are seen. These pins 38 which are seen closeup and magnified in FIG. 16 are for insertion through bores 43 of the side members of the cart and then into the respective bore 26 on each of the side member's extensions 24A, and 24B of the ramp. These pins 38 help secure the friction fit. If desired to prevent loss, pins 38 can be attached by a wire and a screw to a suitable area for storage during the non-engaged periods. Such a construction is well known in the art. Note also the presence in this figure of the spaced L-beam guide rails 36 to be discussed in more detail, infra.

In FIG. 5, there is seen a view similar to FIG. 4. The brace 18 and the cross members 25 that extend between the side members of the ramp are clearly seen. Whereas brace 18 is recessed, the cross members 25 will rest on the ground to support the ramp when the ramp is in the horizontal position.

As has been stated earlier, the apparatus of this invention is designed to be carried by a hand truck. This is shown in FIG. 7. Here the hand truck 15 is seen with a set of travel rails 60 installed on the basic hand truck. Travel rails 60, permit the travel arms 61 to be raised and lowered as desired. The attachment of travel rails 60 to a hand truck is known to the art and forms no part of this invention. The raising and lowering of the travel arms is controlled by the motor 62 and its associated gear system, which are well known in the art.

In FIG. 7, the underside of the cart 10's platform portion 14, as well as the ramp portion 11 are seen. The underside of the platform portion 14 of the invention is seen to include a pair of spaced I-beam guide rails 36, and a series of spaced crossbeams 35 which crossbeams commence at the very front of the platform and terminate at the rear thereof disposed between the two spaced side rails 33A,33B, of the platform portion. The side rails are preferably configured as square or rectangular tubes. The guide rails 36 are two in number 36A the “longer” outer rails and 36B the “shorter” inner rails. See FIG. 7. The outer rails 36A extend from the first or front cross member, 35, to the fourth such spaced cross member, while the inner rails 36B extend from the second cross member 35 near the front end of the platform portion, to the last cross member at the rear of the platform portion. The guide rails are mounted beneath the series of cross members distal to the platform skin 37 spaced from each other in order to receive the travel arms 61 there between as is seen in FIG. 7 to ensure no slippage.

A pair of similar lock pins 63 tethered to a first end of a cable 64 which in turn is attached on its second end to a mount screw 65 attached to, preferably the underside of one of the side rails 33A,33B respectively. The lock pin 63 is used to couple the travel arms 61 of the hand truck to a respective guide rail of the platform portion. This is accomplished through insertion of the respective lock pin through aperture 67 in the respective travel arm of the forklift and the respective guide rail set 36A,36B within which the travel arm 61 is disposed.

The front locking casters 39 and the rear swivel casters 40 are seen in closer proximity here in FIG. 7. Each locking caster 39 includes a conventional fixed mount 46, and a wheel 49, while each swivel caster—shown canted in FIG. 7, has a conventional swivel mount 47 and a wheel 49, usually formed of polyurethane. The receiver's 50, seen also in FIG. 1 have already been described. An optional front bumper of urethane or metal may be disposed over the first of the cross-members and beneath the skin 21 of the platform portion.

### Loading of Copier or Other Large Box Application

FIGS. 8-12 depicts a side view of the loading of the cart 10 of this invention with a photocopier 12. This total process utilizes an elapsed time of about one minute if the load has wheels or casters, and perhaps a few moments more if the box has no wheels or casters.

In FIG. 8, the ramp is attached and the center of gravity is leftwardly as is seen by the presence of the tapered sections being tilted such that the bottom surfaces thereof, 23B is seen to be resting on the ground. In FIG. 8, casters 131 of copier 13 are just approaching the tilted cart. Note the disposition of 13ST, the top of the sorter.

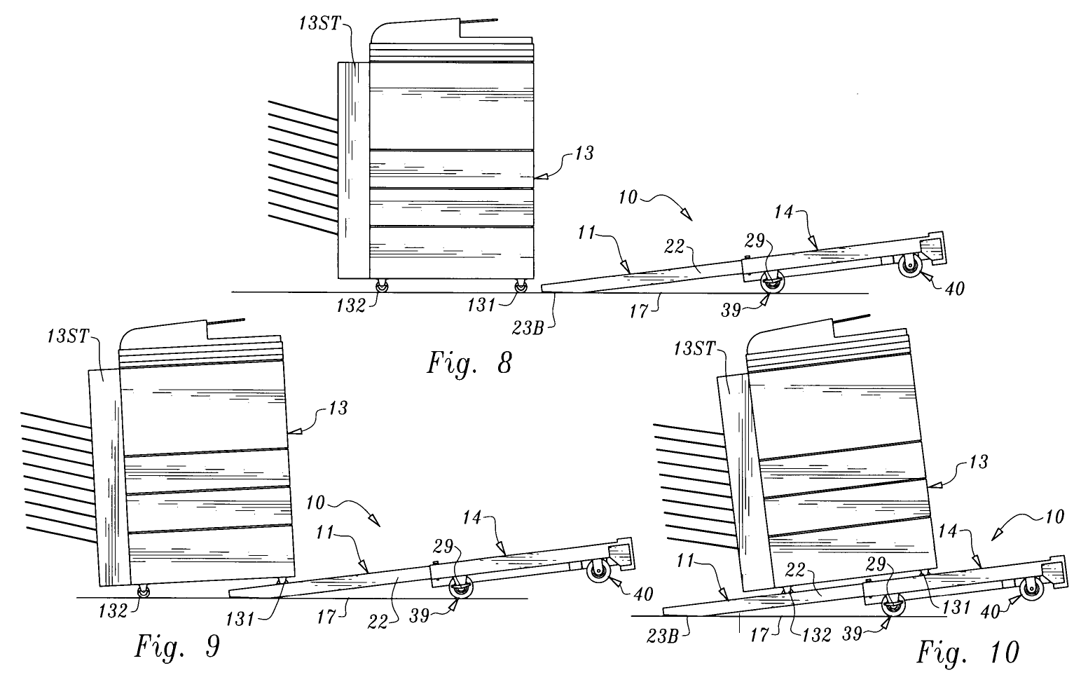

In FIG. 9, casters 131 of the appliance have now been rolled onto the ramp 11, but the pivot point 29 is such that the cart position has not changed. The top of the sorter 13ST, has now changed to a smaller angle closer to the ground.

Moving on to FIG. 10, the copier 13 has been pushed further up the ramp such that the casters 131 of the copier are in the pallet portion 14's skin re sheet metal surface 37; while the casters 132 of the copier are still on the ramp.

Note how the non-locking casters 40 of the cart rear remain up in the air all through the time period of FIGS. 8-10. Here in FIG. 10, the disposition of the copier's sorter top 13ST is still the same as noted in FIG. 9.

The discussion now moves to FIG. 11, which is the superimposed view depicting the moment in time that the center of gravity of the cart changes as the cart is moved rearwardly from the tilted ramp to a position entirely on the platform of the cart. As can be seen section 23, the tapered lower forward edge of the cart is seen in two positions. These are on the ground, and in the air. When the copier has advanced rearwardly such that the casters 132 near the copier's sorter have reached that platform such that none of the copier is on the ramp, the center of gravity of the cart which is located in the vicinity of locking casters 39 switches such that the ramp and platform assume an almost horizontal position as shown by the down arrow 32 which depicts the downward movement of the non-locking casters 40.

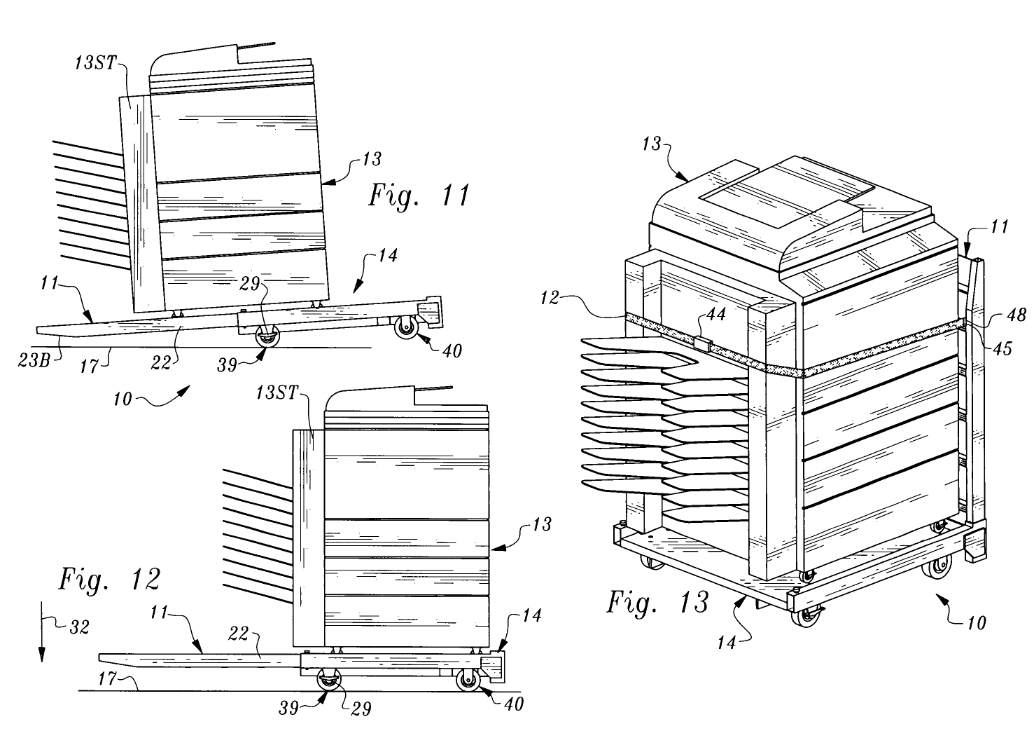

In FIG. 12, the copier is fully upon the platform, the change in the center of gravity of the ramp has already changed. The ramp is extending totally horizontally and all four casters beneath the platform are on the ground 17.

It is now time to remove the ramp from its position horizontally at the front of the cart and move the ramp to a vertical disposition at the rear of the cart.

Once loaded, the console copier 13 is seen in FIG. 13 to be sitting on the cart 10's platform 14, held by restraining strap 12. Each end of the strap 12 is connected to a tie point 48, by a strap anchor 45, in a conventional manner, on the underside of the ramp and a non-scratching buckle 44 is used to tighten the strap to tightly retain the copier 13 or other appliance.

FIG. 14 is related to FIGS. 5 and 7 in that this figure also shows the cart 10 disposed upon a hand truck, though the perspective is different. And the viewer is more distant from the two pieces of equipment. Here the buckle 44 self engaged but not around a copier is easily seen. Since the stair climbing hand truck seen in this figure is a prior art item, no further description of it will be given, other than to mention the balance rails 58 which are attached at their proximal ends, normal to their respective travel rail 60. The distal ends thereof are supported by at least one wheel 59. Here two are shown for better support. These balance rails 58 change the center of gravity of the stair climbing hand truck with the cart sitting thereon, such that the truck remains upright as is seen in this 14^{th} figure.

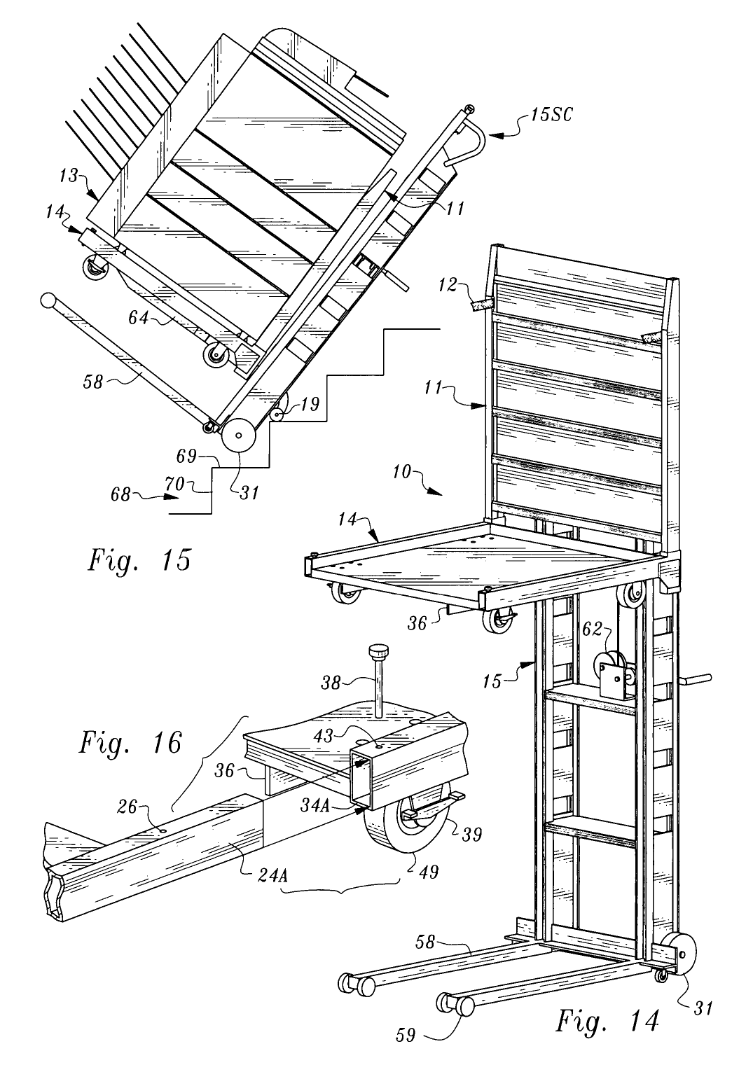

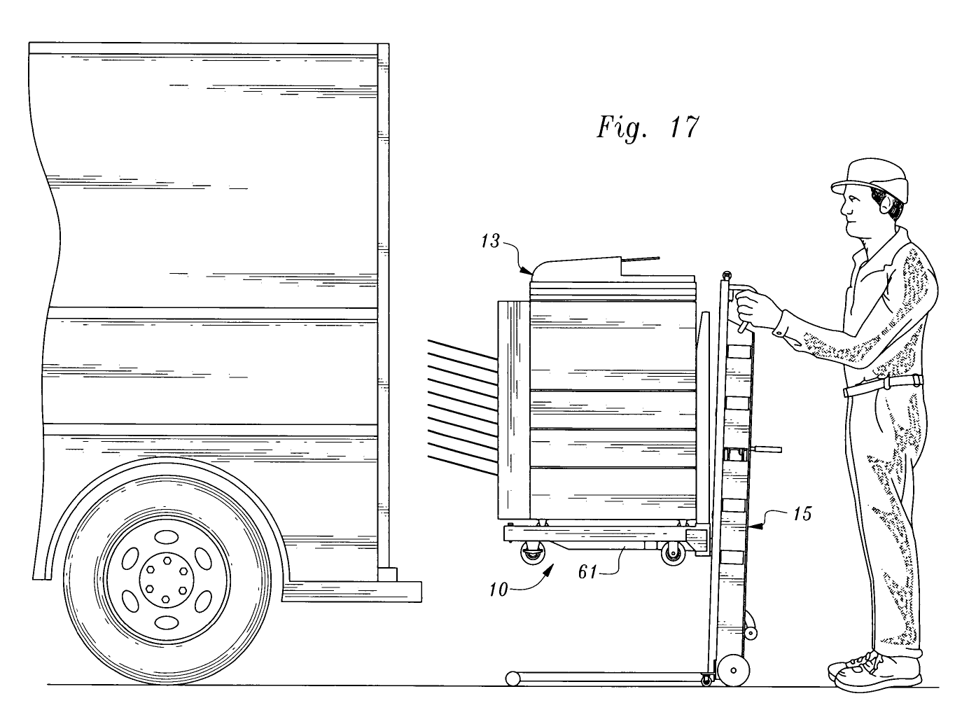

The discussion now moves to FIG. 15. Here we see the loaded hand truck carrying the cart of this invention with a copier 13 disposed thereon as seen in the static figure, FIG. 13. We see the cam wheel set 19 resting at a moment in time on the second tread 69 of “stairs” 68. Wheels 31, only of which is seen, of the hand truck is shown in midair, between second riser 70 and the first tread 69. The mechanics of movement of the stair climbing hand truck need not be discussed as such is well known in the art. Suffice it to say that the balance rails 58 play no part in this upward movement, which retains the cart with the copier in a fixed position safe from harm as the ascendancy goes forth.

FIG. 16, the last figure has been discussed supra.

The copier 13 seen in FIG. 17 is loaded on a cart 10, which in turn is disposed upon the travel arms 61 of the hand truck 15, the cart 10 serves as a pallet or raised platform to permit the forks or travel arms of a hand truck to be placed under the cart to raise and lower the loaded cart vertically for the loading and unloading thereof from a van or truck.

The use of the cart also provides a measure of safety to the copier or other apparatus from being inadvertently damaged by the tynes, since the cart is interposed between the travel arms (tynes) and the load. Again, see FIG. 17. Note that for the ease of drawing the retention straps for the copier base have not been illustrated.

It is seen that I have disclosed a device which can be used not only for the transportation on a single floor, as well as up/down stairways, for the movement of console copiers—though the lateral and upward movement of these business machines—was the basis for the invention, but also for the movement of household washers, and dryers for homes and apartment buildings, and small refrigerators/freezers as are often found in business offices. Laterally on the cart alone, upwardly/downwardly on stairs, by attachment of the cart onto a stair climbing hand truck.

Since certain changes may be made in the described apparatus without departing from the scope of the invention herein involved, it is intended that all matter contained in the above description and shown in the accompanying drawings shall be interpreted as illustrative and not in a limiting sense.

1. A cart apparatus for the lateral transportation of console copiers and other large appliances comprising a ramp and a wheeled platform portion,
a. the ramp having spaced side member with a first end of said spaced members, a forward positioned upwardly tapered bottom surface
b. and having engagable second end, engagable with a wheeled platform portion, both at a front first end of said platform portion in a generally horizontal disposition, and at the rear end of the platform in a generally vertical disposition, whereby when engaged at the front end of said platform, and said platform is empty, the center of gravity shifts such that the tapered underside of the platform touches the ground.

2. A cart apparatus for the lateral transportation of console copiers and other large appliances comprising a ramp and a wheeled platform portion, the ramp having spaced side members with a first end of said spaced side members having a forward positioned upwardly tapered bottom surface and an engagable second end of said side members, engagable with a 4-wheel wheeled platform portion, both at a front first end of said platform portion in a generally horizontal disposition, and said second end being engagable at the rear end of the platform in a generally vertical disposition, whereby when engaged at the front end of said platform, and said platform is empty, the center of gravity shifts such that the tapered underside of the platform's side members touch the ground for easy loading; and the platform portion is raised at the distal unconnected second end off the ground and into the air,
and whereby after a load is moved up the ramp onto the platform portion, both the platform portion and the first end of said ramp assume a generally horizontal disposition with all 4 wheels grounded, such that the ramp can now be readily removed for a vertical disposition into the second end of said platform portion to serve as a force receiving member for pushing cart forwardly.

3. The apparatus of claim 1 wherein the platform portion has locking casters as its wheels at the forward end, and non-locking casters at the other end.

4. The apparatus of claim 1 wherein the platform portion is a pair of opposed side members, each have an inward facing elongated slot therein, in which slot is disposed the skin upon which a load is to be disposed.

5. (canceled)

6. The apparatus of claim 1 wherein the ramp further includes a series of spaced cross members disposed beneath the skin.

7. The apparatus of claim 6 wherein the first cross member of the ramp is spaced rearwardly from the front of the platform and the last cross member is at the rear thereof.

8. The apparatus of claim 1 wherein the platform portion includes an upstanding rear stop rail disposed normal to and abutting said side members.

9. The apparatus of claim 1 wherein the platform portion includes a series of spaced cross members disposed beneath the skin, normal to said side members and further including a pair of guide rails, disposed normal to said cross members, each inwardly spaced from its respective side member and spaced from each other.

10. The apparatus of claim 6 wherein the ramp includes a pair of tie points for the receipt of retaining strap anchors for load securement.

11. The device of claim 8 wherein the side rails of the platform portion each has a front end and a rearward end, which rearward end is adjacent the rear stop rail and an open top receiver to receive said ramp in a vertical disposition is disposed rearwardly of the rearward end of each of said side rails.

12. (canceled)

13. The apparatus of claim 3 wherein the platform portion's locking casters are the front casters and the platform portion has opposed parallel side rails that are tubular.

14. The apparatus of claim 2 wherein the ramp includes a series of spaced cross members disposed beneath a skin, which skin overlays a pair of spaced side members, said skin having a length lesser than the length of said side members.

15. A cart apparatus for the lateral transportation of console copiers and other large appliances comprising a ramp and a wheeled platform portion;
the ramp having a first end with a forward positioned upwardly tapered bottom surface at its outer edges, and said ramp having an engagable second end, engagable with a 4-wheeled platform portion, both at a front first end of said platform portion in a generally horizontal disposition, and at the rear end of the platform in a generally vertical disposition, whereby when engaged at the front end of said platform, and said platform is empty, the center gravity shifts such that the tapered underside of the platform touches the ground for easy loading; and the platform portion is raised at the unconnected second end off the ground and into the air,
and whereby after a load is moved up the ramp onto the platform portion, both the platform portion and the first end of said ramp assume a generally horizontal disposition, such that the ramp can be readily removed for a vertical disposition into the second end of said platform portion;
said platform portion having a series of spaced cross members disposed beneath the skin, normal to said side members and having horizontally open receiving areas in the front and vertically open receiving areas at the rear for said ramp's engagable second end,
further including a pair of guide rails, disposed normal to and at a lower elevation than said cross members, each guide rail being inwardly spaced from its respective side member and spaced from each other;
wherein the ramp comprises a pair of spaced side members, each having an inwardly facing slot with a skin disposed therein, the side members each having an extension thereon that is disposed rearwardly of said skin, distal to the first end of said ramp said spaced side members serving as the engagable second end of said ramp.

16. The apparatus of claim 15 wherein the platform portion has a set of front casters locking casters.

17. The apparatus of claim 16 wherein the ramp includes a pair of tie points for the receipt of retaining strap anchors for load securement.
